(19) United States
(12) Patent Application Publication
(10) Pub. No.: US 2010/0095279 A1
(43) Pub. Date: Apr. 15, 2010

(54) METHOD FOR AUTOMATICALLY TESTING MENU ITEMS OF APPLICATION SOFTWARE

(75) Inventor: Wen-Yong Chou, Taipei (TW)

Correspondence Address: KIRTON AND MCCONKIE, 60 EAST SOUTH TEMPLE,, SUITE 1800, SALT LAKE CITY, UT, 84111, US

(73) Assignee: PRIMAX ELECTRONICS LTD., Taipei (TW)

(21) Appl. No.: 12/325,621

(22) Filed: Dec. 1, 2008

(30) Foreign Application Priority Data
Oct. 9, 2008 (TW) 097138830

(51) Int. Cl. G06F 9/44

(52) U.S. Cl. 717/128

(57) ABSTRACT

An automatic testing method is used for automatically testing multiple menu items of application software. The application software is executed to display a window including the multiple menu items on a screen. The method includes the following steps. Firstly, multiple serial numbers are assigned to respective menu items of the application software by automatic testing tool software. Then, an automatic testing script including multiple command symbols and the serial numbers is produced. The functions of the multiple menu items of the window are implemented, thereby outputting an automatic testing result.

### FIELD OF THE INVENTION

The present invention relates to a testing method, and more particularly to an automatic testing method for automatically testing menu items of specified application software.

### BACKGROUND OF THE INVENTION

Due to the amazing power of computers, computers are widely used to implement diversified functions. With rapid development of the computers, the hardware components and the software components of the computers are increasingly improved. For performing specified functions, a large number of application software may be designed by many software manufacturers. In a case that the old version of the application software has some errors, the manufacturer may correct the errors and then publish the update version. Alternatively, the manufacturer may publish an advanced version or an enhanced version of the application software in order to expand the functions thereof. Before the update version or the enhanced version is published, the application software should be tested in order to assure that the functions are executable.

As known, the conventional method of testing the application software is labor-intensive. In other words, the testers need to test functions of all menu items of the application software. The menu items of the application software are successively selected and the implementations of the selected application software are examined in order to realize whether the application software can execute the expected functions.

FIG. 1 is a schematic view illustrating a window of specified application software under a Windows operating system. The specified application software is for example Microsoft Word software, which is word processing software capable of adding texts or graphics. As shown in FIG. 1, the menu bar of the window of the Microsoft Word software contains several menu items such as a “File” item, an “Edit” item, a “View” item, an “Insert” item, a “Format” item, a “Tool” item, a “Table” item, a “Window” item and a “Help” item. In addition, each of these menu items contains many sub-menu items and some of the sub-menu items contain additional sub-menu items. In other words, the menu items are arranged as a multi-level hierarchy. In accordance with the conventional testing method, all menu items and their sub-menu items need to be tested. Until the functions of all of the tested menu items are successfully implemented without any erroneous response, the application software passes the test. In a case that the function of a certain menu item fails to be accurately implemented, the failure item of the regression test is recorded by the tester and then corrected by the researchers. Since this testing method is labor-intensive and inefficient, an automatic testing method has been disclosed in order to solve these drawbacks.

By the automatic testing method, the functions of all menu items need to be manually implemented by the tester once. During the functions of all menu items are manually implemented by the tester, the regression testing results are recorded by the computer. Later, the recorded regression testing results are re-played such that the computer may automatically perform the regression test. Although the recoding and re-playing steps of the automatic testing method can automatically test the application software, there are still some drawbacks. For example, since the recording step is manually performed, the automatic testing method is also labor-intensive. Moreover, since only the recorded regression testing results are re-played, the recording and re-playing steps of the automatic testing method can only be used to test the same application software. When other application software or the update version thereof is tested, the recorded regression testing results fail to be re-played and thus the functions of all menu items need to be manually executed by the tester again. In other words, the conventional recoding and re-playing method is neither user-friendly nor practical.

### SUMMARY OF THE INVENTION

An object of the present invention provides an automatic testing method for automatically testing multiple menu items of application software so as to achieve the labor-saving purpose.

Another object of the present invention provides an automatic testing method for automatically testing multiple menu items of application software without the recoding and re-playing steps.

In accordance with an aspect of the present invention, there is provided an automatic testing method for automatically testing multiple menu items of application software. The application software is executed to display a window including the multiple menu items on a screen. The method includes the following steps. Firstly, multiple serial numbers are assigned to respective menu items of the application software by automatic testing tool software. Then, an automatic testing script including multiple command symbols and the serial numbers is produced. The functions of the multiple menu items of the window are implemented, thereby outputting an automatic testing result.

In an embodiment, the command symbols comprise LeftClick, OpenFile and SelectTab.

In an embodiment, the automatic testing result comprises an automatic testing successful message and an automatic testing erroneous message. If the functions of the multiple menu items are successfully implemented, the automatic testing successful message is issued. If the functions of the multiple menu items are erroneously implemented or unable to be successively implemented, the step of implementing the functions of the multiple menu items is suspended and the automatic testing erroneous message is issued.

In an embodiment, the multiple menu items comprise a first menu item, a second menu item and a third menu item. A first serial number is assigned to the first menu item, a second serial number is assigned to the second menu item, and a third serial number is assigned to the third menu item.

In an embodiment, the first menu item, the second menu item and the third menu item have a first data structure, a second data structure and a third data structure, respectively.

In an embodiment, the first data structure includes the first serial number, a first item category or a first layer number, the second data structure includes the second serial number, a second item category or a second layer number, and the third data structure includes the third serial number, a third item category or a third layer number.

In an embodiment, the functions of the multiple menu items are implemented by triggering multiple hot keys.

In an embodiment, the application software is Microsoft Word software.

In an embodiment, the multiple menu items includes a “File” item, a “New file” item, an “Open file” item, a “Close file” item, a “Save file” item and a “Print” item.

In an embodiment, a print dialog box including a “Properties” item is displayed when the “Print” item is clicked and selected, and an additional dialog box including an “Advanced” item is displayed when the “Properties” item is clicked and selected.

In an embodiment, the first menu item is the “Advanced” item, the first serial number is 1-6, the first item category is a tab item, and the first layer number is 1.

In an embodiment, the second menu item is a “Paper Option” item displayed on the additional dialog box.

In an embodiment, the second serial number is 2-9, the second item category is an option category, and the second layer number is 2.

In an embodiment, the third menu item is a “Print Quality” item displayed on the additional dialog box.

In an embodiment, the third serial number is 2-23, the second item category is an option category, and the third layer number is 2.

In an embodiment, the automatic testing tool software further comprises a script debugging function for checking whether a programming syntax specification of the automatic testing script is accurate or erroneous.

In an embodiment, an erroneous script message is issued if the programming syntax specification of the automatic testing script is erroneous, and an accurate script message is issued if the programming syntax specification of the automatic testing script is accurate.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating a window of an application software under a Windows operating system;

FIG. 2 schematically illustrates a flowchart of an automatic testing method for automatically testing menu items of an application software according to the present invention;

FIG. 3 schematically illustrates a dialog box displayed on a window, of the application software under the Windows operating system;

FIG. 4 schematically illustrates another dialog box displayed on a window of the application software under the Windows operating system;

FIG. 5 schematically illustrates a window of the application software under the Windows operating system by clicking and selecting a second tab item of a first menu item;

FIG. 6 schematically illustrates a window of the application software under the Windows operating system by using the automatic testing tool software to assign respective serial numbers to the sub-menu items of the second tab item;

FIG. 7 schematically illustrates a window of the application software under the Windows operating system by clicking the third tab item;

FIG. 8 schematically illustrates a window of the application software under the Windows operating system by using the automatic testing tool software to assign respective serial numbers to the sub-menu items of the third tab item; and

FIG. 9 is a schematic diagram illustrating a window displaying the proceeding and the result of testing the application software by the automatic testing tool software.

### DETAILED DESCRIPTION OF THE PREFERRED EMBODIMENT

As previously described, the conventional method of testing specified application software is inefficient and impractical. For obviating the drawbacks encountered from the prior art, the present invention provides an automatic testing method for automatically testing the menu items of specified application software.

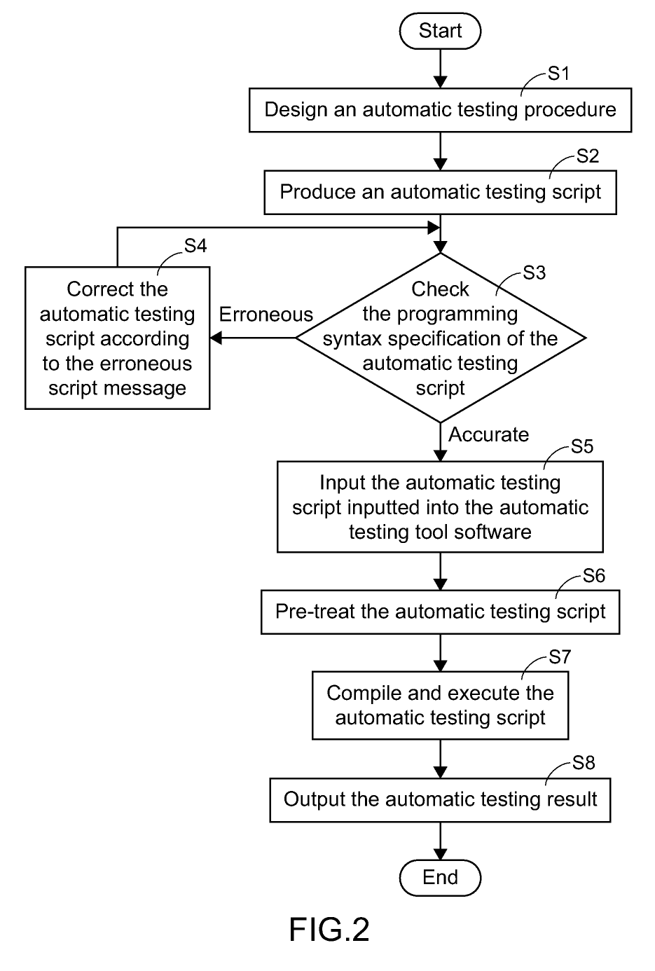

The present invention utilizes automatic testing tool software to automatically test the application software. Hereinafter, a method for automatically testing the menu items of the application software according to the present invention will be illustrated with reference to the flowchart of FIG. 2.

First of all, an automatic testing procedure is designed (Step S1). Next, an automatic testing script is written (Step S2). Next, the programming syntax specification of the automatic testing script is checked (Step S3). If the programming syntax specification of the automatic testing script is erroneous, an erroneous script message is issued and thus the automatic testing script should be corrected according to the erroneous script message (Step S4). After the automatic testing script is corrected, the programming syntax specification of the corrected automatic testing script is checked again (Step S3). Whereas, if the programming syntax specification of the automatic testing script is accurate, the automatic testing script will be directly inputted into the automatic testing tool software (Step S5). Meanwhile, an accurate script message indicative of no error is issued. Next, a pretreatment of the automatic testing script is done (Step S6). After the pretreatment, the automatic testing script is compiled and executed (Step S7). Afterwards, the executing result is discriminated and automatic testing result is outputted (Step S8).

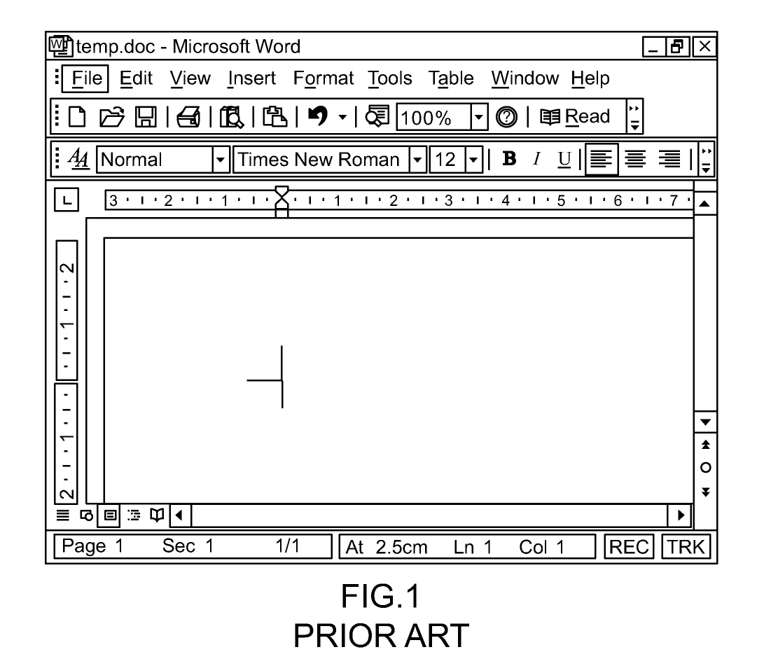

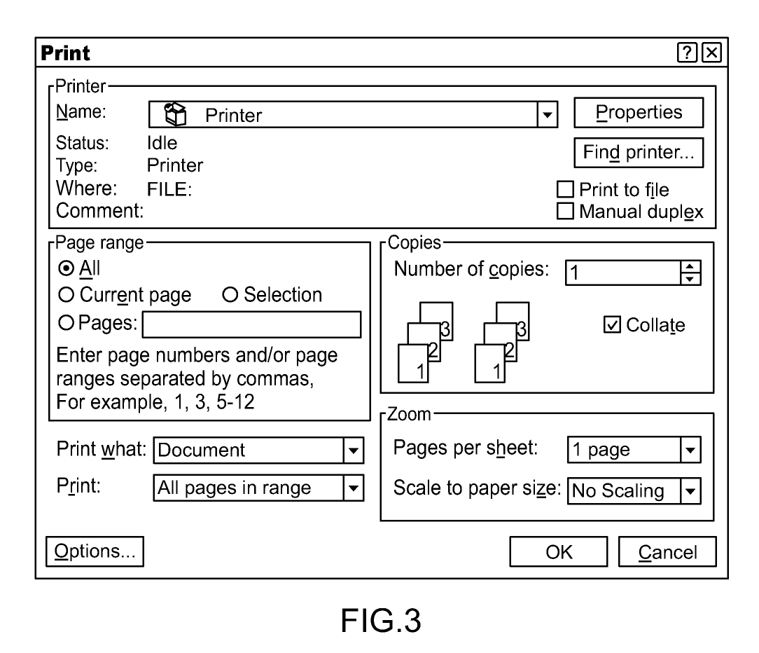

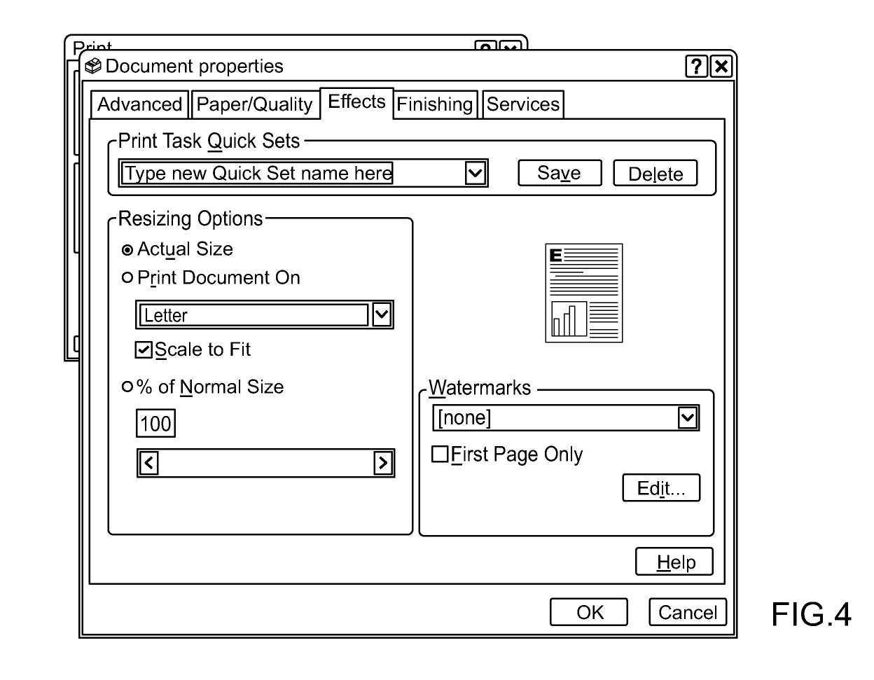

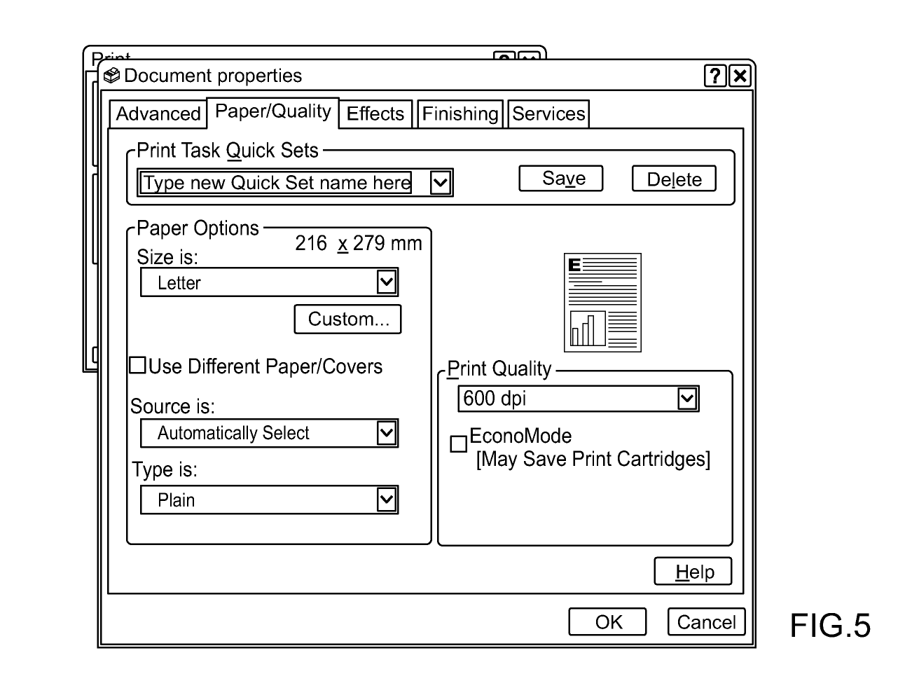

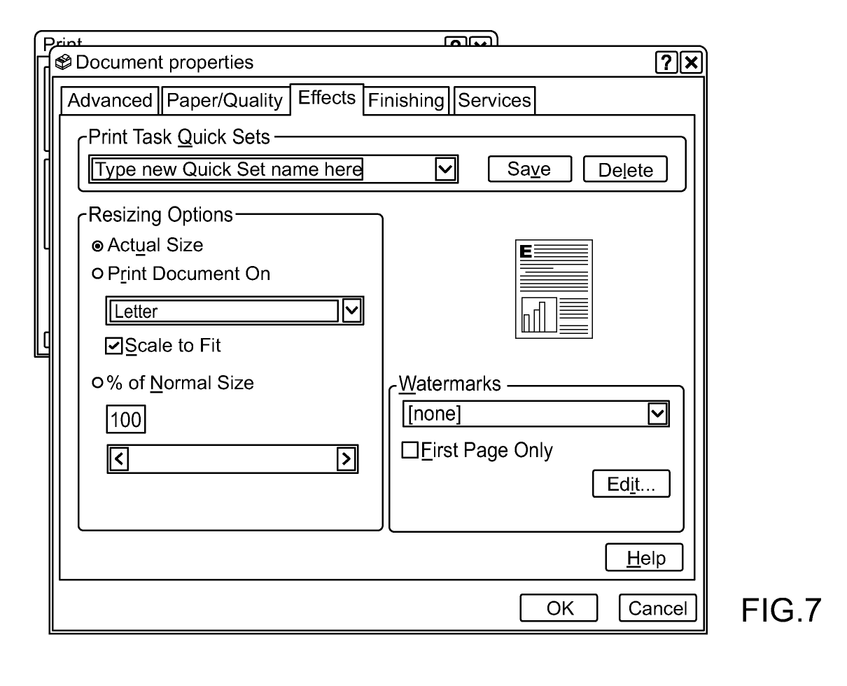

In this embodiment, the application software to be tested is for example Microsoft Word software, which has a window as shown in FIG. 1. The step of designing the automatic testing procedure (Step S1) will be illustrated as follows. The menu bar of the window of the Microsoft Word software contains several menu items such as a “File” item, an “Edit” item, a “View” item, an “Insert” item, a “Format” item, a “Tool” item, a “Table” item, a “Window” item and a “Help” item. For testing the Microsoft Word software, the menu items and their sub-menu items are successively selected and the implementations of the selected application software are examined in order to realize whether the application software can execute the expected functions. Take the printing function of the Microsoft Word software for example. For testing the printing function, the menu item “File” is clicked and selected, and thus several sub-layered menu items including a “New file” item, an “Open file” item, a “Close file” time, a “Save file” item and a “Print” item are shown. After the “Print” item is clicked and selected, a print dialog box is displayed on the window, as can be seen in FIG. 3. After the sub-menu item “Properties” on the print dialog box is clicked and selected, another dialog box having the title “Document properties” is shown, as can be seen in FIG. 4. The dialog box “Document properties” comprises an “Advanced” item, which is one kind of tab item. The “Advanced” item comprises an “Advanced” tab item, a “Paper/Quality” tab item, an “Effects” tab item, a “Finishing” tab item and a “Services” tab item. In a case that the tab items are clicked and selected, no additional dialog box is displayed. The contents of respective tab items are distinguishable such that the user may change corresponding settings. For example, as shown in FIG. 5, if the “Paper/Quality” tab item is clicked and selected, the user may change the paper size settings or the paper type setting via this dialog box. In addition, as shown in FIG. 7, after the “Effects” tab item is clicked and selected, the paper scale settings can be made. After the confirmation key “OK” is clicked, the print dialog box as shown in FIG. 3 appears again. After the print page number is inputted via the print dialog box and the confirmation key “OK” is clicked, the printing operation is performed.

The step of producing the automatic testing script (Step S2) will be illustrated as follows. In the Step S2, the automatic testing procedure is converted into a programming language in order to achieve the automatic testing purpose. In this embodiment, the programming syntax specification of the automatic testing script should comply with the automatic testing tool software. The command symbols used in the automatic testing script of the present invention are listed in the following table.

| Command | | |
|---|---|---|
| symbol | Parameter | Description |
| LeftClick | menu item or text | Single left click to enable the menu |
| | or numeral | item or input text or numeral |
| SelectTab | “title of Tab | Select a Tab Item |
| | Item” | |
| OutPutDialog | “string” \| “string” | Create a dialog box |
| SetParameter | control | Set some parameters |
| | identification = | |
| | “value” | |
| Wait | “time” | Waiting time (sec) |
| SaveScreen | “file path | Save the window of the current |
| | filename” | screen into the current folder (if no |
| | | complete path is designated) |
| FileExist | “file” | Check if the file exists |
| StartUpApp | “file path” | Activate a program |
| WindowTitle | “window title” | Designate the title of the window to |
| | | be operated |
| AppPath | “path” | Designate the path of the |
| | | application software |
| OpenFile | “file path” | Open a designated file |
| NewUI | | Indicate a new UI interface |
| SelectPrint | | Print |
| CloseWindow | “window title” | Close a window |
| GetFileInfo | “file path” | Acquire information of a designated |
| | | file |
| SaveScreen | “file path” | Save the window of the current |
| | | screen into a designated file |
| PrintString | “string” | Output a designed string |
| CurrentTime | | Output the current time |
| MacroFile | “file path” | Designate the path of a Micro file |
| If | _If (Variable != | An “If” sentence is used for |
| | or ==Value) | discriminating whether the equality |
| | { | or inequality is true, thereby |
| | Statements | executing or not executing the |
| | } | statement included in the { } |
| PressKey | “key” | Click a key |
| PressNKey | “key-N” | Press a key for several times |
| AltKey | “key” | Press Alt + key name |
| CtrlKey | “key” | Press Ctrl + key name |
| Input | “string” | Input a string |

In this embodiment, a Word file that has a file name “temp.doc” and is stored in the disk C of the computer system is opened. According to the command symbols and the programming syntax specification described above, the automatic testing tool software compiles the following automatic testing script:

_OpenFile “C:\Temp\temp.doc”
_Wait “2”
_CtrlKey “p”
_Wait “2”
_PressKey “Tab”
_PressKey “p”
_Wait “2”
_OutputDialog “Document Properties”
_If(OutputDialog == “”)
{
_SaveScreen “C:\temp\printsetting”
_PrintString “******************************”
_PrintString “Print property setting error!”
_PrintString “******************************”
Exit “”
}
_WindowTitle “Document Properties”
_SelectTab “Paper/Quality”
_SetParameter 2-9 = “Letter” & 2-23 = “600 dpi ”
_Wait “2”
_SelectTab “Effects”
_LeftClick 2-8
_Wait “2”
_LeftClick 1-2
_PressNKey “Tab-5”
_Input “2,3”
_Wait “2”
_PressKey “Enter”

After the automatic testing script is produced, the programming syntax specification of the automatic testing script is checked (Step S3) by using a script debugging function of the automatic testing tool software. If the automatic testing script does not comply with the programming syntax specification, the erroneous script message is issued and the automatic testing script is then corrected according to the erroneous script message (Step S4). Whereas, if the automatic testing script complies with the programming syntax specification, the accurate script message is issued and the automatic testing script is inputted into the automatic testing tool software (Step S5). After the automatic testing script is inputted into the automatic testing tool software, the automatic testing tool software pre-treats the automatic testing script (Step S6). By the pretreatment, the automatic testing script written by the user is converted into a computer-comprehensible low-level programming language. Next, all lines of the automatic testing script are compiled and executed by the automatic testing tool software (Step S7).

The procedure of compiling the automatic testing script by the automatic testing tool software will be illustrated in more detail as follows. After the first line of the automatic testing script is read by compiling _OpenFile “C:\Temp\temp.doc”, the automatic testing tool software opens a file having a filename “temp.doc”, as is shown in FIG. 2. Next, the procedure waits for two seconds by compiling _Wait “2”. Next, the key Ctrl and the key P are pressed by compiling _CtrlKey “p” in order to execute the print item of the Microsoft Word software. Next, the key P is pressed by the automatic testing tool software such that a print dialog box as shown in FIG. 3 is displayed. Next, the procedure waits for two seconds again by compiling _Wait “2”. After the key Tab is pressed by compiling _PressKey “Tab”, the key P is pressed and then the procedure waits for two seconds again by compiling _Wait “2”, the following automatic testing script is continuously compiled:

_OutputDialog “Document Properties”
_If(OutputDialog == “”)
{
_SaveScreen “C:\temp\printsetting”
_PrintString “******************************”
_PrintString “Print property setting error!”
_PrintString “******************************”
Exit “”
}
_WindowTitle “Document Properties”

In a case that the function of the menu item “Properties” on the print dialog box is accurately executed, another dialog box “Document properties” as shown in FIG. 4 is displayed on the window. On the other hand, if no dialog box “Document properties” is displayed after the keys “Tab+P” are pressed by the automatic testing tool software, it is meant that there is an erroneous function in the Microsoft Word software. Meanwhile, the window of the current screen indicating creation of no dialog box “Document properties” is stored into the document folder “temp” of the disk C. The window is also saved as a file having a filename “printsetting” and then the following string is displayed:
property setting error!

After the above string is displayed on the window of the automatic testing tool software, the compiling and executing tasks of the automatic testing tool software are exited. In other words, the stored window and the displayed string are employed to message the user that the function of the Microsoft Word software is erroneous and fails to be accurately executed. By viewing the displayed string, the tester may realize the erroneous part of the Microsoft Word software so as to perform a debugging procedure.

In a case that all functions of the Microsoft Word software are normal, the operations of the application software testing method will be illustrated as follows. Please refer to the dialog box “Document properties” as shown in FIG. 4 again. After the tab item “Paper/Quality” is clicked and selected by compiling _SelectTab “Paper/Quality”, the next-layered menu items of the tab item “Paper/Quality” as shown in FIG. 5 are displayed. Next, by compiling _SetParameter 2-9=“Letter” & 2-23=“600 dpi”, the paper size is adjusted to a “Letter” size and the print quality is adjusted to be 600 dpi. The procedure of setting the paper size and the print quality will be illustrated in more details later. After the paper size and the print quality are adjusted, the procedure waits for two seconds by compiling _Wait “2”. Next, the tab item “Effects” is clicked and selected by compiling _SelectTab “Effects”, the next-layered menu items of the tab item “Effects” as shown in FIG. 7 are displayed. Next, the menu item having the assigned serial number 2-8 is left clicked by compiling _LeftClick 2-8. After the procedure waits for two seconds by compiling _Wait “2”, the menu item having the assigned serial number 1-2 is left clicked by compiling _LeftClick 1-2. The contents of the menu items having the assigned serial numbers 2-8 and 1-2 will be illustrated in more details later. After the menu item having the assigned serial number 1-2 is left clicked, the dialog box “Document properties” is closed and returned to the “Print” dialog box. Next, by compiling _PressNKey “Tab-5”, the key “Tab” is pressed for five times such that the mouse cursor is moved to the menu item “Pages”. Next, by compiling _Input “2,3”, the string “2,3” is inputted into the menu item “Pages”. After the procedure waits for two seconds by compiling _Wait “2”, the key “Enter” is pressed by compiling _PressKey “Enter”. Meanwhile, the second page and the third page of the file “temp.doc” can be printed out.

The procedure of setting the paper size and the print quality by the automatic testing tool software and the contents of the menu items corresponding to the serial numbers 2-8 and 1-2 will be illustrated in more details as follows.

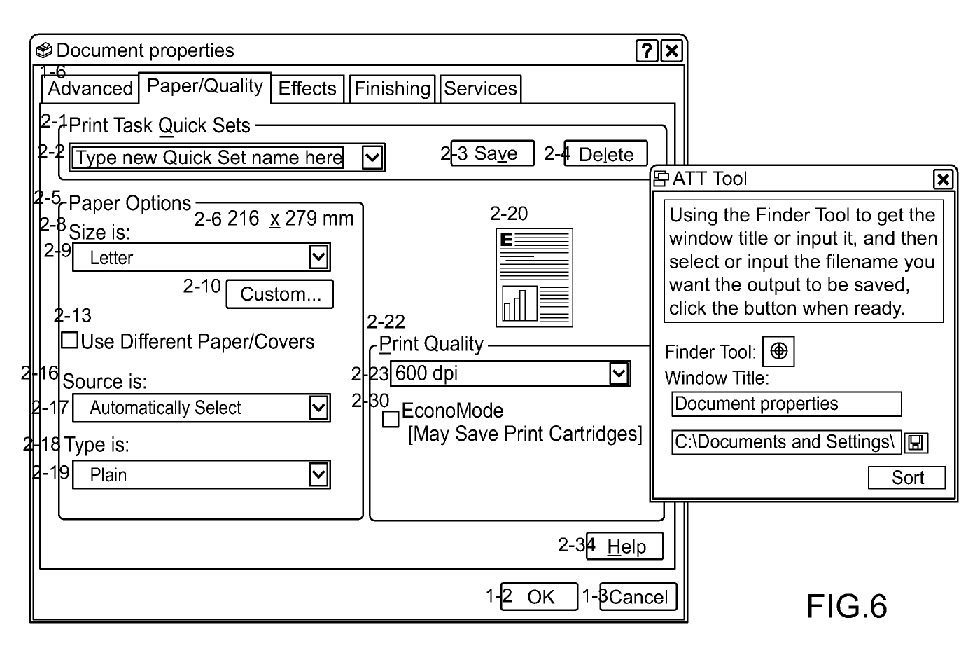

During the application software is tested by the automatic testing tool software, it is usually difficult to realize the position of the menu item being executed and thus the function of the menu item fails to be accurately executed. For solving these drawbacks, respective serial numbers are assigned to the menu items by the automatic testing tool software. For executing a function of a specified menu item by the automatic testing tool software, the menu item having the assigned serial number is left clicked according to the present invention. Take a paper size setting for example. Referring to FIG. 5 again, the next-layered menu items of the tab item “Paper/Quality” are displayed. Before the menu item “Paper Option” is selected, respective serial numbers are assigned to the menu items shown on the “Advanced” dialog box by the automatic testing tool software. As shown in FIG. 6, a first serial number 1-6 is assigned to the tab item “Advanced” shown on the first layer of the “Advanced” dialog box, wherein the layer number of the tab item “Advanced” is 1. In addition, a serial number 2-5 is assigned to the title of the menu item “Paper Option”. A second serial number 2-9 is assigned to the menu item of paper size setting, wherein the layer number of the menu item “Paper Option” is 2. Similarly, a serial number 2-22 is assigned to the title of the menu item “Print Quality”. A third serial number 2-23 is assigned to the menu item “Print Quality”, wherein the layer number of the menu item “Print Quality” is also 2.

The menu items described above have respective data structures. Each of the data structures comprises a serial number, an item category, or a layer number. In other words, the data structure of the tab item “Advanced” includes the first serial number 1-6, a first item category (e.g. a tab item category) and the first layer number. Similarly, the data structure of the menu item of paper size setting has a second serial number 2-9, a second item category (e.g. an option item category) and the second layer number. The layer number is advantageous for facilitating the automatic testing tool software to recognize the position of the menu item. The working principle of the layer number is known in the art, and is not redundantly described herein. Since all of the menu items have respective assigned serial numbers, the functions of these menu items can be implemented by the automatic testing tool software if the assigned serial numbers are written into the automatic testing script.

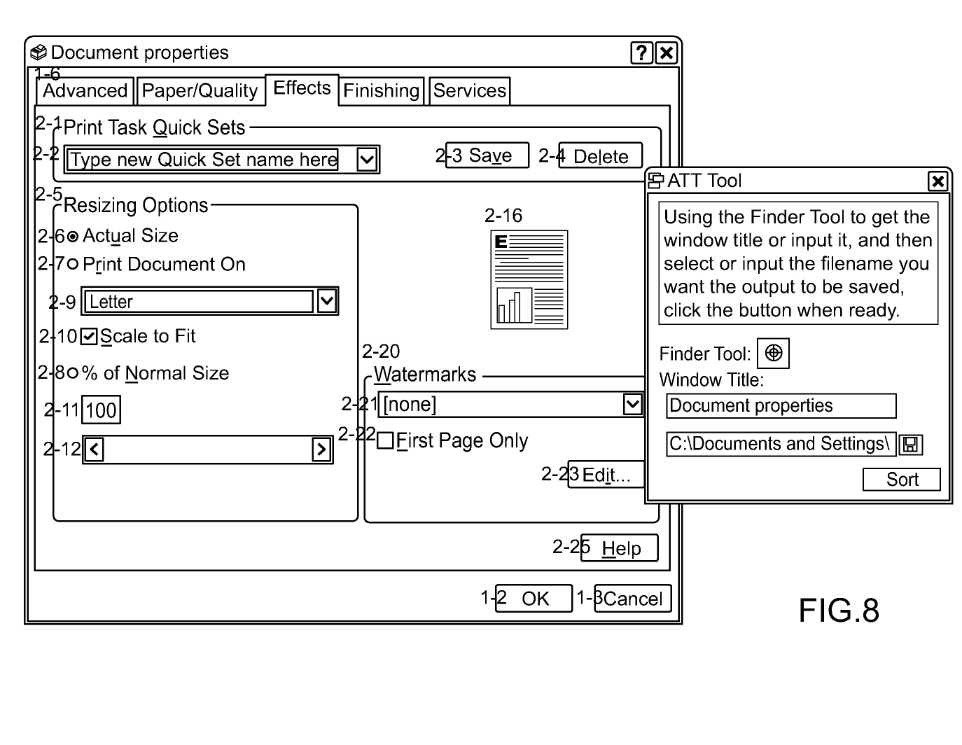

Similarly, respective serial numbers are assigned to the menu items under the tab item “Effects”. FIG. 8 is a schematic diagram illustrating the serial numbers assigned to the menu items under the tab item “Effects” by the automatic testing tool software. As shown in FIG. 8, a serial number 2-8 is assigned to the menu item “% of Normal Size”. After the menu item having the assigned serial number 2-8 is left clicked by compiling _LeftClick 2-8 and the menu item having the serial number 1-2 (i.e. the key “OK”) is left clicked by compiling _LeftClick 1-2, the function of the menu item “% of Normal Size” is implemented.

According to the settings of the automatic testing tool software, the same serial number is possibly assigned to different menu items. Please refer to FIGS. 6 and 8. The serial number 2-23 as shown in FIG. 6 is assigned to the menu item “Print Quality”. Whereas, the serial number 2-23 as shown in FIG. 8 is assigned to the menu item “Edit”. The menu item “Print Quality” as shown in FIG. 6 and the menu item “Edit” as shown in FIG. 8 are both arranged at the second layer. Since the serial numbers are assigned to menu items displayed on the current window by the automatic testing tool software, no identical serial number is assigned to different menu items on the same window. In other words, the automatic testing tool software can implement the functions of the menu items having assigned serial numbers without causing confusion.

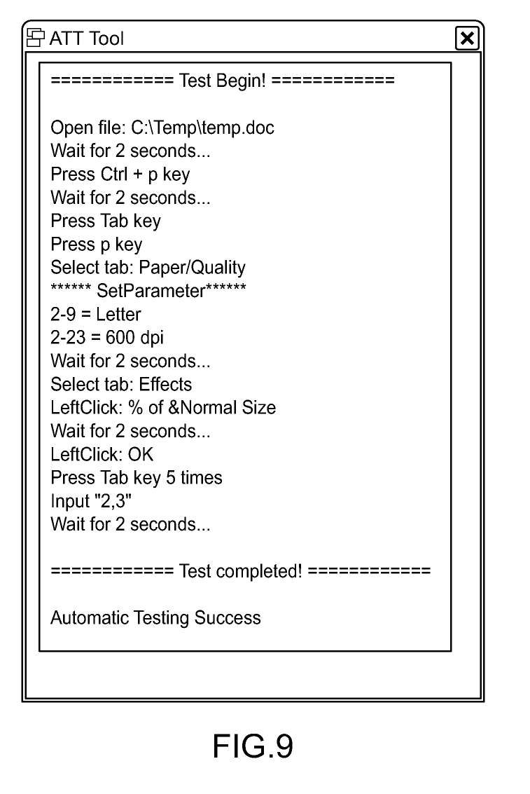

FIG. 9 is a schematic diagram illustrating a window displaying the proceeding and the result of testing the application software by the automatic testing tool software. When an automatic testing script is compiled and executed by the automatic testing tool software, the testing procedure is displayed on the window of the automatic testing tool software. If the functions of the multiple menu items are erroneously implemented or unable to be successively implemented, the testing procedure is suspended and an automatic testing erroneous message is issued. The automatic testing erroneous message may be displayed on the window of the automatic testing tool software as a string. Alternatively, the automatic testing erroneous message may be displayed on the screen as a dialog box. On the other hands, if the functions of the multiple menu items are successfully implemented, an automatic testing successful message is issued. Similarly, the automatic testing successful message may be either displayed on the screen as a dialog box or on the screen as a dialog box.

In some embodiments, the functions of some menu items (e.g. “File” or “Print”) may be implemented by triggering corresponding hot keys. The present invention is not restricted to implement the functions of the menu items by triggering corresponding hot keys. Nevertheless, after the menu items that have respective serial numbers assigned by the automatic testing tool software are left clicked, the functions of corresponding menu items are implemented. The automatic testing method of the present invention is capable of testing any application software. An example of the application software includes but is not limited to the Microsoft Word software. Moreover, the application software is not restricted to be executed under the Windows operating system. That is, the application software may be executed under any operating system.

From the above description, the automatic testing method of the present invention is capable of automatically testing multiple menu items of application software by producing an automatic testing script. Since respective serial numbers are assigned to the menu items, the automatic testing method of the present invention can solve the drawback of difficultly clicking and selecting the menu items. As previously described, the conventional process of testing the application software is labor-intensive. In addition, the conventional recording and re-playing method fails to test the menu items that have not yet been recorded. Whereas, according to the automatic testing method of the present invention, the automatic testing script may be modified as required. As a result, the automatic testing method of the present invention is more practical, labor-saving and efficient in comparison with the conventional methods.

During the application software is tested by the automatic testing tool software, it is difficult to realize the position of the menu item being executed and thus the function of the menu item fails to be accurately executed. For solving these drawbacks, all are by the automatic testing tool software.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An automatic testing method for automatically testing multiple menu items of application software, said application software being executed to display a window including said multiple menu items on a screen, said method comprising steps of:
assigning multiple serial numbers to respective menu items of said application software by automatic testing tool software;
producing an automatic testing script including multiple command symbols and said serial numbers;
implementing functions of said multiple menu items of said window; and
outputting an automatic testing result.

2. The automatic testing method according to claim 1 wherein said command symbols comprise LeftClick, OpenFile and SelectTab.

3. The automatic testing method according to claim 1 wherein said automatic testing result comprises an automatic testing successful message and an automatic testing erroneous message, wherein if the functions of said multiple menu items are successfully implemented, said automatic testing successful message is issued, and if the functions of said multiple menu items are erroneously implemented or unable to be successively implemented, said step of implementing said functions of said multiple menu items is suspended and said automatic testing erroneous message is issued.

4. The automatic testing method according to claim 1 wherein said multiple menu items comprise a first menu item, a second menu item and a third menu item, a first serial number is assigned to said first menu item, a second serial number is assigned to said second menu item, and a third serial number is assigned to said third menu item.

5. The automatic testing method according to claim 4 wherein said first menu item, said second menu item and said third menu item have a first data structure, a second data structure and a third data structure, respectively.

6. The automatic testing method according to claim 5 wherein said first data structure includes said first serial number, a first item category or a first layer number, said second data structure includes said second serial number, a second item category or a second layer number, and said third data structure includes said third serial number, a third item category or a third layer number.

7. The automatic testing method according to claim 1 wherein said functions of said multiple menu items are implemented by triggering multiple hot keys.

8. The automatic testing method according to claim 6 wherein said application software is Microsoft Word software.

9. The automatic testing method according to claim 8 wherein said multiple menu items includes a “File” item, a “New file” item, an “Open file” item, a “Close file” item, a “Save file” item and a “Print” item.

10. The automatic testing method according to claim 9 wherein a print dialog box including a “Properties” item is displayed when said “Print” item is clicked and selected, and an additional dialog box including an “Advanced” item is displayed when said “Properties” item is clicked and selected.

11. The automatic testing method according to claim 10 wherein said first menu item is said “Advanced” item, said first serial number is 1-6, said first item category is a tab item, and said first layer number is 1.

12. The automatic testing method according to claim 10 wherein said second menu item is a “Paper Option” item displayed on said additional dialog box.

13. The automatic testing method according to claim 12 wherein said second serial number is 2-9, said second item category is an option category, and said second layer number is 2.

14. The automatic testing method according to claim 10 wherein said third menu item is a “Print Quality” item displayed on said additional dialog box.

15. The automatic testing method according to claim 14 wherein said third serial number is 2-23, said second item category is an option category, and said third layer number is 2.

16. The automatic testing method according to claim 16 wherein said automatic testing tool software further comprises a script debugging function for checking whether a programming syntax specification of said automatic testing script is accurate or erroneous.

17. The automatic testing method according to claim 16 wherein an erroneous script message is issued if said programming syntax specification of said automatic testing script is erroneous, and an accurate script message is issued if said programming syntax specification of said automatic testing script is accurate.
